(19) United States
(12) Patent Application Publication
(10) Pub. No.: US 2008/0297330 A1
(43) Pub. Date: Dec. 4, 2008

(54) VEHICLE EMERGENCY PREVENTIVE TERMINAL DEVICE AND INTERNET SYSTEM USING FACIAL RECOGNITION TECHNOLOGY

(76) Inventor: Byong-Hoon JEON, SEOUL (KR)

Correspondence Address: IPLA P.A., 3580 WILSHIRE BLVD., 17TH FLOOR, LOS ANGELES, CA, 90010, US

(21) Appl. No.: 12/021,170

(22) Filed: Jan. 28, 2008

(30) Foreign Application Priority Data
Jun. 1, 2007 (KR) 10-2007-0053874

(51) Int. Cl. B60R 25/04

(52) U.S. Cl. 340/426.11

(57) ABSTRACT

A danger preventive apparatus employing a facial recognition technology and a danger preventive system using the same is provided. According to the present invention, the robbery of a vehicle, and various crimes and unexpected dangers within a vehicle can be prevented and eliminated by employing a facial recognition algorithm. Further, dangerous situations can be solved rapidly by automatically transmitting a driver's position information and pertinent images from an external danger prevention server to external helpers, such as police and emergency help institutes, through wireless Internet communication technologies such as Wibro (also called Mobile WiMAX), HSDPA & HSUPA, Long Term Evolution (LTE), Ultra Mobile Broadband (UMB), TD-SCDMA, TRS, GPRS (GSM) and CDMA, when the robbery or danger of a vehicle is sensed in the danger preventive apparatus.

### CROSS REFERENCES

Applicant claims foreign priority under Paris Convention and 35 U.S.C. §119 to Korean Patent Application No. 10-2007-0053874, filed Jun. 1, 2007 with the Korean Intellectual Property Office.

### BACKGROUND OF THE INVENTION

1. Field of the Invention

The present invention relates to a danger preventive apparatus employing a facial recognition technology and a danger preventive system using the same, in which the robbery of a vehicle, and various crimes and unexpected dangers within a vehicle can be prevented and eliminated by employing a facial recognition algorithm.

2. Background of the Related Art

In general, a vehicle robbery prevention device is adapted to prevent robbery by identifying a driver within a vehicle and then giving an alarm or preventing the startup of the vehicle when the driver is not a registered driver.

Korean Patent Publication No. 10-241387 discloses a driver recognizing apparatus in which an image of a driver, which is captured by a camera, is detected, only the face area of the driver of the detected image is detected and then is compared with a driver's face image registered within the vehicle in order to determine whether the driver is a registered driver, and a burglar alarm is generated when the driver is not the registered driver. However, the prior art 10-241387 adopts a method of simply comparing a face area picture (image) of a captured face image with a previously stored picture (image), and is therefore disadvantageous in that a driver image is recognized as other images due to external conditions, such as a driver's expression, whether a driver wears eyeglasses or a hat, a change of the hairstyle, a change of the face contour due to a changed body weight, whether a driver wears a mask, age, a photographing angle, a change of an illumination and the like.

Further, when a third party drives a vehicle by forcedly actuating a starting system after neglecting start-up prevention of the vehicle, no action can be taken against the robbery of the vehicle. There is another problem in that no further action can be taken against dangerous situations, such as burglar and thief, which occur within a vehicle after a driver is authenticated.

### SUMMARY OF THE INVENTION

Accordingly, the present invention has been made in view of the above problems occurring in the prior art, and it is an object of the present invention to provide a danger preventive apparatus employing a facial recognition technology and a danger preventive system using the same, in which the robbery of a vehicle, and various crimes and unexpected dangers within a vehicle can be prevented and eliminated by employing a facial recognition algorithm.

Another object of the present invention is to provide a danger preventive apparatus employing a facial recognition technology and a danger preventive system using the same, in which dangerous situations can be solved rapidly by automatically transmitting a driver's position information and pertinent images from an external danger prevention server to external helpers, such as police and emergency help institutes, through wireless Internet communication technologies such as Wibro (also called Mobile WiMAX), HSDPA & HSUPA, Long Term Evolution (LTE), Ultra Mobile Broadband (UMB), TD-SCDMA, TRS, GPRS (GSM) and CDMA, when the robbery or danger of a vehicle is sensed in the danger preventive apparatus.

To achieve the above objects, a danger preventive apparatus employing a facial recognition technology according to the present invention includes: a camera for capturing a driver's face image; a driver registration unit for storing and managing a driver's face vector template, the driver's face vector template being utilized as an authentication key; a driver face vector template acquisition unit for converting the driver's face image captured by the camera into a digital image stream, storing the converted digital image stream in a memory, and generating the driver's face vector template in real-time using the facial recognition technology; a danger content management unit for storing and managing contents for a danger warning, which are output when a danger is generated within the vehicle; a driver authentication unit for comparing/analyzing the driver's face vector template generated from the driver face vector template acquisition unit and the driver's face vector template registered with the driver registration unit in order to determine whether the driver is a registered driver, and determining that the danger of burglary exists in the vehicle when an unauthorized person tries to drive the vehicle; a driver face image reader for generating the driver's face vector template from the digital image stream stored in the memory using the facial recognition technology; an inter-vehicle safety situation determination unit for continuously monitoring the driver's safety situation within the vehicle by comparing/analyzing the driver's face vector template, which is generated in real-time from the driver face vector template acquisition unit after user authentication, and the driver's face vector template registered with the driver registration unit; and a danger content output unit for outputting contents for a burglar alarm or emergency situations when the driver authentication unit or the inter-vehicle safety situation determination unit determines that the danger of robbery or an emergency situation has occurred within the vehicle.

Further, a danger prevention system employing a facial recognition technology according to the present invention includes a danger preventive apparatus installed within a vehicle and a danger prevention server communicating with the danger preventive apparatus wirelessly,

wherein the danger preventive apparatus includes a driver registration unit for storing and managing a driver's face vector template, the driver's face vector template being utilized as an authentication key; a camera for capturing a driver's face image; a driver face vector template acquisition unit for converting an analog image of the driver's face image captured by the camera into a digital image stream, storing the converted digital image stream in a memory, and generating the driver's face vector template in real-time using the facial recognition technology; a danger content management unit for storing and managing contents for a danger warning, which are output when a danger is generated within the vehicle; a driver authentication unit for comparing/analyzing the driver's face vector template generated from the driver face vector template acquisition unit and the driver's face vector template registered with the driver registration unit in order to determine whether the driver is a registered driver, and determining that the danger of burglary exists in the vehicle when an unauthorized person tries to drive the vehicle; a driver face image reader for generating the driver's face vector template from the digital image stream stored in the memory using the facial recognition technology; an inter-vehicle safety situation determination unit for continuously monitoring the driver's safety situation within the vehicle by comparing/analyzing the driver's face vector template, which is generated in real-time from the driver face vector template acquisition unit after user authentication, and the driver's face vector template registered with the driver registration unit; a danger content output unit for outputting contents for a burglar alarm or emergency situations when the driver authentication unit or the inter-vehicle safety situation determination unit determines that the danger of robbery or an emergency situation has occurred within the vehicle; and a communication unit for providing the stored driver face vector template, authorization information and images of the vehicle, information and images of the vehicle's danger of burglary, information and images of an emergency situation within the vehicle, and the vehicle's position information to the outside through a wireless Internet communication, and

wherein the danger prevention server includes a member registration unit for registering an owner of the danger preventive apparatus, who is provided with various services for robbery and danger prevention through a wireless Internet, as a member, and storing the owner's ordinary face vector template, who drives the vehicle having the danger preventive apparatus mounted therein, in a member DB; a helper registration unit for storing and managing information about an external helper to which the vehicle's robbery situation or a driver's dangerous situation will be sent; a danger content management unit for storing and managing contents for robbery prevention and danger; a server communication unit for receiving the stored driver face vector template, authorization information and images of the vehicle, information and images of the vehicle's danger of burglary, information and images of an emergency situation within the vehicle, and the vehicle's position information from the danger preventive apparatus through a wireless Internet communication; a member authentication unit for comparing the driver's face vector template received from the danger preventive apparatus and the owner's face vector template registered with the member DB in order to determine whether the driver is a service member; a danger content service unit for allowing the danger preventive apparatus to output the contents for robbery prevention and danger, which are stored in the danger preventive apparatus, when information and images of the vehicle's danger of burglary and information and images of the vehicle's emergency situation are stored in the information received from the danger preventive apparatus after member authentication; and an external helper connection unit for transmitting the occurrence of robbery and a danger, image information, and the vehicle's position information to the external helper when information and images of the vehicle's danger of burglary and information and images of the vehicle's emergency situation are included in the information received from the danger preventive apparatus after member authentication.

### BRIEF DESCRIPTION OF THE DRAWINGS

Further objects and advantages of the invention can be more fully understood from the following detailed description taken in conjunction with the accompanying drawings in which:

FIG. 1 is a schematic view of a danger prevention system employing a facial recognition technology according to the present invention;

FIG. 2 is a block diagram of a danger preventive apparatus according to the present invention;

FIG. 3 is a block diagram of a danger prevention server according to the present invention; and

FIG. 4 is a flowchart illustrating a danger prevention method according to the present invention.

### DETAILED DESCRIPTION OF THE PREFERRED EMBODIMENT

The present invention will now be described in detail in connection with specific embodiments with reference to the accompanying drawings.

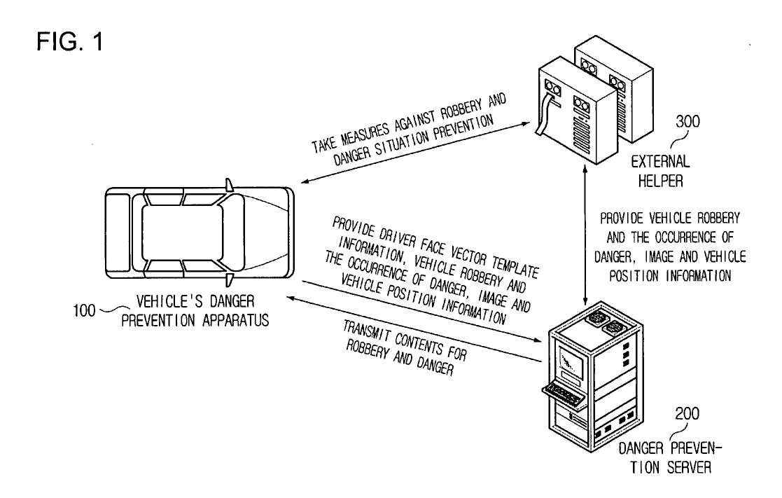

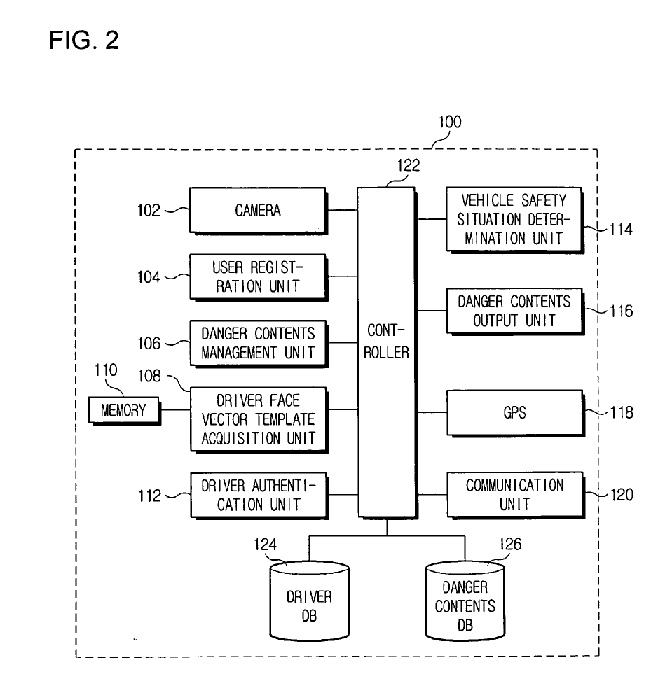

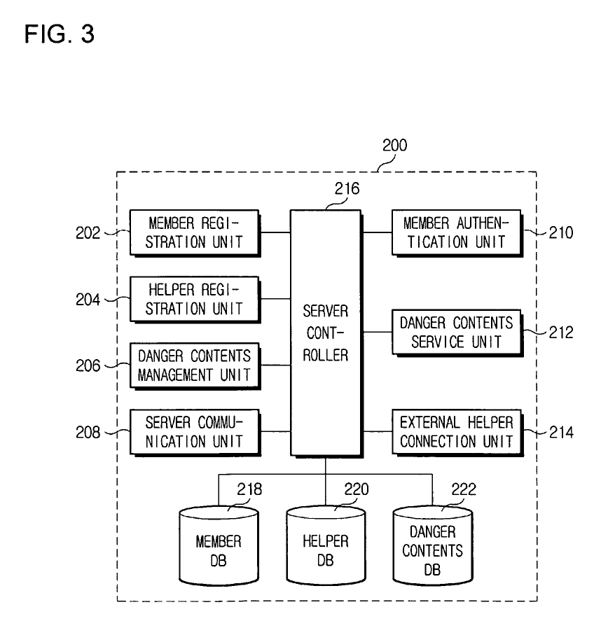

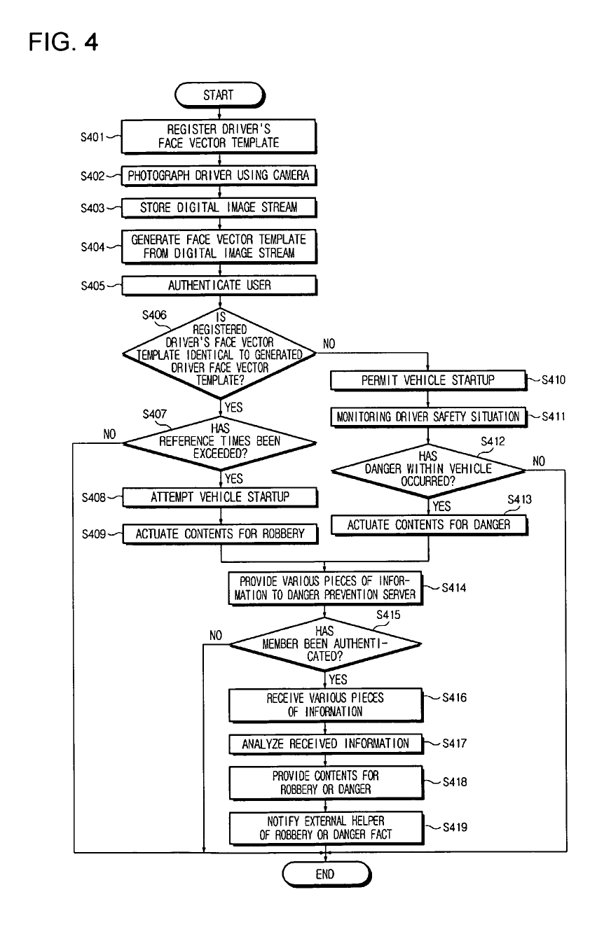

FIG. 1 is a schematic view of a danger prevention system employing a facial recognition technology according to the present invention. FIG. 2 is a block diagram of a danger preventive apparatus according to the present invention. FIG. 3 is a block diagram of a danger prevention server according to the present invention. FIG. 4 is a flowchart illustrating a danger prevention method according to the present invention.

Referring to FIG. 1, according to the present invention, a face vector template, of a driver's face image captured by a camera 102 of a danger preventive apparatus 100, is generated and then compared with a face vector template of a driver, which has been registered at normal times, in order to determine the robbery of a vehicle or various crimes and dangerous situations while driving. If it is determined that the robbery of the vehicle or a danger has occurred, a variety of warning methods for preventing the robbery or danger are executed. The robbery or danger information sensed within the vehicle and pertinent captured images are transmitted to a danger prevention server 200, which then performs robbery and danger contents for the vehicle. The robbery or danger information of the vehicle and pertinent captured images are also transmitted to an external helper 300 so that an action can be taken rapidly.

As shown in FIG. 2, the danger preventive apparatus 100 includes a camera 102, a driver registration unit 104, a danger content management unit 106, a driver face vector template acquisition unit 108, a driver authentication unit 112, an inter-vehicle safety situation determination unit 114, a danger content output unit 116, a Global Positioning System (GPS) 118, a communication unit 120 and a controller 122.

The camera 102 is installed to photograph a driver's face and captures an image of a driver when the driver drives a car.

The driver registration unit 104 registers a face vector template of a driver who drives a car with a driver DB 124 in order to utilize the registered face vector template as an authentication key for determining whether a driver is a registered driver and updates a registered face vector template. The driver's face vector template refers to a numerical value which is obtained by extracting several hundreds of geometrical characteristic elements on the basis of the eyes, nose, mouth, etc., which constitute the driver's face, on a face region image, and has a data size smaller than that of an original face image. On the other hand, when a number of users such as a car for the family or a car for a company exist, all the users can be registered as drivers.

The danger content management unit 106 stores contents for a burglar alarm or emergency situations such as digital images, sound, text, and text-to-speech, which are output through an audio or multimedia display device of a vehicle, in the danger content DB 126 when the vehicle is a stolen vehicle or an emergency situation occurs within the vehicle, and manages the contents stored in danger content DB 126.

The driver face vector template acquisition unit 108 converts a driver's analog image, which is captured in the camera 102, into a digital image stream, stores the digital image stream in cyclic memory 110, and generates a driver's face vector template in real-time using a facial recognition technology. When a driver's face vector template is not generated from a photographed image, the driver face vector template acquisition unit 108 displays an error message so as to call the driver's attention.

The driver authentication unit 112 compares/analyzes a driver's face vector template, which is generated in the driver face vector template acquisition unit 108, and a driver's vector template stored in the driver DB 124 in order to determine whether the driver is a registered driver. If, as a result of the determination, the driver's face vector template generated from the driver face vector template acquisition unit 108 is identical to the driver's vector template stored in the driver DB 124, the driver authentication unit 112 permits the start-up of the vehicle. If the driver's face vector template generated from the driver face vector template acquisition unit 108 is not identical to the driver's vector template stored in the driver DB 124, the driver authentication unit 112 repeatedly compares the driver's face vector template generated from the driver face vector template acquisition unit 108 with another registered driver's face vector template. If a certain number of mismatches occur in the driver face vector template and an unauthorized person attempts to drive the vehicle, the driver authentication unit 112 determines that there is the danger of burglary in the vehicle and outputs robbery prevention contents through various multimedia devices.

The inter-vehicle safety situation determination unit 114 compares/analyzes a driver's face vector template, which is generated in real-time from the driver face vector template acquisition unit 108 after driver authentication, and the driver's vector template or a previous vector template stored in the driver DB 124 in order to continuously monitor the vehicle's safety situation within the driver. For example, in a taxi, in the event that a driver's face vector template is not generated or a driver's face vector template is inclined at a specific area of the camera because a passenger suddenly turns into a burglar while the taxi driver drives the car or the taxi driver is deviated from his original position due to an emergency situation such as a traffic accident, the inter-vehicle safety situation determination unit 114 can determine that an emergency situation has occurred in the taxi.

The danger content output unit 116 outputs the contents for a burglar alarm or emergency situations such as digital images, sound, text, and text-to-speech, which are stored in the danger content DB 126, through audio or multimedia devices of a vehicle when the driver authentication unit 112 or the inter-vehicle safety situation determination unit 114 determines that a stolen vehicle or an emergency situation within a vehicle has occurred.

The GPS 118 functions to track a vehicle's position.

The communication unit 120 transmits a driver's face vector template generated from the driver face vector template acquisition unit 108, authorization information and images of a vehicle, information and images of a vehicle's danger of burglary, information and images of a vehicle's emergency situation, and a vehicle's position information provided from the GPS to the danger prevention server 200 through wireless Internet communications such as Wibro (or Mobile WiMAX), HSDPA & HSUPA, LTE, UMB, TD-SCDMA, TRS, GPRS (GSM) or CDMA.

The controller 122 controls the data flow in the danger preventive apparatus 100.

As shown in FIG. 3, the danger prevention server 200 includes a member registration unit 202, a helper registration unit 204, a danger content management unit 206, a server communication unit 208, a member authentication unit 210, a danger content service unit 212, an external helper connection unit 214 and a server controller 216.

The member registration unit 202 registers therewith an owner of the danger preventive apparatus 100, who is provided with various services for robbery and danger prevention through a wireless Internet, as a member. The member registration unit 202 receives an ordinary face vector template of a driver who drives a car having the danger preventive apparatus 100 mounted therein and stores the received ordinary face vector template in member DB 218.

The helper registration unit 204 stores information about the external helper 300, such as an owner of a vehicle, family, and a close acquaintance who will be received with a robbery situation or dangerous situation of a vehicle and is specified by a member, in the member DB 218, and stores information about external helpers, such as police office and an emergency rescue center, in a helper DB 220.

The danger content management unit 206 stores contents, such as digital images, sound, text, and text-to-speech for robbery prevention and dangers, in a danger content DB 222, and manages the contents stored in the danger content DB 222. The contents stored in the danger content DB 222 can be provided to the danger preventive apparatus 100 for updating purpose.

The server communication unit 208 receives a driver's face vector template, authorization information and images of a vehicle, information and images of a vehicle's danger of burglary, information and images of a vehicle's emergency situation, and a vehicle's position information provided from the GPS from the danger preventive apparatus 100 through wireless Internet communications such as Wibro (or Mobile WiMAX), HSDPA & HSUPA, LTE, UMB, TD-SCDMA, TRS, GPRS (GSM) or CDMA. The received information is stored in the member DB 218. Further, the server communication unit 208 provides various pieces of information to the external helper while communicating with the external helper in a wired or wireless manner.

The member authentication unit 210 compares a driver's face vector template, which is received from the danger preventive apparatus 100, and a face vector template stored in the member DB 218 in order to determine whether the driver is a service member.

The danger content service unit 212 provides stored contents for robbery prevention and dangers to the danger preventive apparatus 100 when information and images of a vehicle's danger of burglary and information and images of a vehicle's emergency situation are included in information received from the danger preventive apparatus after member authentication.

If the member authentication unit 210 determines that a vehicle has been stolen or the danger content service unit 212 determines that an emergency situation has occurred in a vehicle, the external helper connection unit 214 informs the external helper 300, which is registered with the helper DB 220, of the occurrence of robbery or danger by sending image information and a vehicle's position information, which are received from the danger preventive apparatus 100, to the external helper 300 through SMS (or MMS), voice messages, a wireless telephone, e-mail through the Internet, or messenger so that the external helper 300 can take an action against the robbery or danger. Alternatively, when a call or SMS (or MMS) is directly received from the external helper 300, the external helper connection unit 214 may connect the external helper 300 to the danger preventive apparatus 100.

The server controller 216 controls the data flow within the danger prevention server 200.

A method of preventing robbery and danger in the danger preventive apparatus according to the present invention is described in detail below with reference to the flowchart of FIG. 4.

A user of the danger preventive apparatus 100 stores his own face vector template, which has been extracted from his own face captured by the camera, in the driver DB 124 while registering his own face vector template as a vehicle's driver (step S401). The driver's face vector template refers to a numerical value which is obtained by extracting several hundreds of geometrical characteristic elements on the basis of the eyes, nose, mouth, etc., which constitute the driver's face, on a face region image, and has a data size smaller than that of an original face image.

The camera 102 captures a face image of a driver who tries to drive the vehicle (step S402). The driver face vector template acquisition unit 108 converts the face image information into a digital image stream and stores the digital image stream in the memory 110 (step S403). The driver face vector template acquisition unit 108 then generates a small size vector template based on the digital image stream by employing a facial recognition algorithm for recognizing characteristics unique to the driver face (step S404). At this time, if the driver face vector template is not generated from the captured image, the driver face vector template acquisition unit 108 determines that the captured image is not a driver's face image or an input image is erroneous due to non-control of the camera or non-cooperation of the driver and displays a corresponding error message in order to call the driver's attention. The memory 110 may be cyclic memory that is able to repeatedly store data.

After the driver's face vector template is generated, the driver authentication unit 112 compares/analyzes the driver's face vector template generated by the driver face vector template acquisition unit 108 and the driver's face vector template stored in the driver DB 124 in order to determine a real driver (steps S405 and S406).

If, as a result of the comparison/analysis in steps S405 and S406, the driver's face vector template generated by the driver face vector template acquisition unit 108 is identical to the driver's face vector template stored in the driver DB 124, the driver authentication unit 112 permits the start-up of the vehicle (S410). However, if, as a result of the comparison/analysis in steps S405 and S406, the driver's face vector template generated by the driver face vector template acquisition unit 108 is not identical to the driver's face vector template stored in the driver DB 124, the driver authentication unit 112 repeatedly compares/analyzes another driver's face vector template stored in the driver DB 124 and the driver's face vector template generated by the driver face vector template acquisition unit 108 (step S407). If an attempt to drive the vehicle is made by an unauthorized person in a state where a certain number of mismatches has occurred in the driver face vector template (step S408), the driver authentication unit 112 determines that the danger of burglary exists in the vehicle and outputs contents for robbery prevention, which are stored in the danger content DB 126, through various multimedia devices (step S408).

Meanwhile, if, as a result of the comparison/analysis in steps S405 and S406, the driver's face vector template generated by the driver face vector template acquisition unit 108 is identical to the driver's face vector template stored in the driver DB 124, the inter-vehicle safety situation determination unit 114 continuously monitors the driver's safety situation within the vehicle by comparing/analyzing the driver face vector template, which is generated in real-time from the driver face vector template acquisition unit 108, and the driver's vector template or a previous vector template stored in the driver DB 124 (step S411). For example, in a taxi, in the event that a driver's face vector template is not generated or a driver's face vector template is inclined at a specific area of the camera because a passenger suddenly turns into a burglar while the taxi driver drives the car or the taxi driver is deviated from his original position due to an emergency situation such as a traffic accident, the inter-vehicle safety situation determination unit 114 can determine that an emergency situation has occurred in the taxi.

If the inter-vehicle safety situation determination unit 114 determines that a danger has occurred in the vehicle (step S412), the danger content output unit 116 outputs contents for danger, which are stored in the danger content DB 126, in order to give the driver or a fellow passenger a warning (S413).

On the other hand, the danger preventive apparatus 100 sends the driver's face vector template generated from the driver face vector template acquisition unit 108, authorization information and images of the vehicle, information and images of the vehicle's danger of burglary, information and images of the vehicle's emergency situation, and the vehicle's position information, to the danger prevention server 200 through wireless Internet communications such as Wibro (or Mobile WiMAX), HSDPA & HSUPA, LTE, UMB, TD-SCDMA, TRS, GPRS (GSM) or CDMA (step S414). At this time, the danger preventive apparatus 100 can be configured to immediately send an emergency situation to the danger prevention server 200 manually such as “an emergency call button”. Meanwhile, the received information may be stored in the memory 110 of the danger prevention server 100 and then utilized.

The member authentication unit 210 of the danger prevention server 200 compares the driver face vector template received from the danger preventive apparatus 100 and a face vector template registered with the member DB 218 in order to determine whether the driver is a member driver who is supplied with services for danger prevention at the server (step S415).

If, as a result of the determination in step S415, the driver is a registered member, the member authentication unit 210 receives various pieces of information from the danger preventive apparatus 100 through the server communication unit 208 (step S416). The server communication unit 208 receives all information about the driver, including the driver's face vector template, the vehicle's authorization information and images, information and images of the vehicle's danger of burglary, information and images of the vehicle's emergency situation, and the vehicle's position information, from the danger preventive apparatus and stores the information in the member DB 218.

Meanwhile, when the vehicle's authorization information and images, information and images of the vehicle's danger of burglary, information and images of the vehicle's emergency situation are included in the information received from the danger preventive apparatus 100, the server communication unit 208 provides the contents for robbery prevention or danger, which are stored in the danger content DB 222, to the danger preventive apparatus 100 so that a warning message or alarm is output to the vehicle's driver (steps S417, S418).

However, if, as a result of the determination in step S415, the driver is not a registered member, the member authentication unit 210 outputs a message, informing that the driver is not a registered member, to the danger preventive apparatus 100.

The member authentication unit 210 also provides the vehicle's position information, emergency situation image information within the vehicle, emergence call vehicle information, etc. to the external helper 300 such as the vehicle's owner, police or the like so that the driver can receive appropriate measures (step S419).

Meanwhile, if the danger preventive apparatus 100 determines that an emergency situation has occurred in the vehicle, it can directly send the occurrence of robbery and danger and the vehicle position to the external helper 300 using SMS (or MMS), a voice message, etc. through a wireless Internet communication such as Wibro (or Mobile WiMAX), HSDPA & HSUPA, LTE, UMB, TD-SCDMA, TRS, GPRS (GSM) or CDMA so that the external helper 300 takes appropriate measures. In other words, if a driver presses the “emergency call button” mounted in the danger preventive apparatus 100, a vehicle's position information, emergency situation image information within the vehicle, emergency call vehicle information, and so on can be sent to the external helper 300.

As described above, according to the present invention, the danger preventive apparatus employing the facial recognition technology employs the facial recognition algorithm and is therefore independent from external environment factors, which play an important role in constructing a driver's face image. Accordingly, the danger preventive apparatus is advantageous in that it can prevent the robbery of a vehicle, and various crimes and unexpected dangers within a vehicle on the basis of an excellent recognition ratio.

Further, an image captured within a vehicle is provide to an external danger prevention server through wireless Internet communication technologies such as Wibro (or Mobile WiMAX), HSDPA & HSUPA, LTE, UMB, TD-SCDMA, TRS, GPRS (GSM) or CDMA. Thus, pertinent images and position information can be automatically sent to external helpers such as police and emergency help institutes at the danger prevention server. Accordingly, there is an advantage in that dangerous situations can be solved rapidly.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A danger preventive apparatus employing a facial recognition technology, comprising:
a driver registration unit for storing and managing a driver's face vector template, the driver's face vector template being utilized as an authentication key;
a camera for capturing a driver's face image;
a driver face vector template acquisition unit for converting the driver's face image captured by the camera into a digital image stream, storing the converted digital image stream in a memory, and generating the driver's face vector template in real-time using the facial recognition technology;
a danger content management unit for storing and managing contents for a danger warning, which are output when a danger is generated within the vehicle;
a driver authentication unit for comparing/analyzing the driver's face vector template generated from the driver face vector template acquisition unit and the driver's face vector template registered with the driver registration unit in order to determine whether the driver is a registered driver, and determining that the danger of burglary exists in the vehicle when an unauthorized person tries to drive the vehicle;
a driver face image reader for generating the driver's face vector template from the digital image stream stored in the memory using the facial recognition technology;
an inter-vehicle safety situation determination unit for continuously monitoring the driver's safety situation within the vehicle by comparing/analyzing the driver's face vector template, which is generated in real-time from the driver face vector template acquisition unit after user authentication, and the driver's face vector template registered with the driver registration unit; and
a danger content output unit for outputting contents for a burglar alarm or emergency situations when the driver authentication unit or the inter-vehicle safety situation determination unit determines that the danger of robbery or an emergency situation has occurred within the vehicle.

2. The danger preventive apparatus as claimed in claim 1, further comprising a Global Position System (GPS).

3. The danger preventive apparatus as claimed in claim 1, wherein the driver's face vector template comprise several hundreds of geometrical characteristic elements on the basis of the eyes, nose, mouth and so on.

4. The danger preventive apparatus as claimed in claim 1, further comprising a communication unit for providing the stored driver face vector template, authorization information and images of the vehicle, information and images of the vehicle's danger of burglary, information and images of an emergency situation within the vehicle, and the vehicle's position information to the outside through a wireless Internet communication.

5. The danger preventive apparatus as claimed in claim 4, wherein the communication unit is actuated when an emergency call button is pressed.

6. A danger prevention system employing a facial recognition technology, the system being equipped with a danger preventive apparatus installed within a vehicle and a danger prevention server communicating with the danger preventive apparatus wirelessly,
wherein the danger preventive apparatus comprises:
a driver registration unit for storing and managing a driver's face vector template, the driver's face vector template being utilized as an authentication key;
a camera for capturing a driver's face image;
a driver face vector template acquisition unit for converting an analog image of the driver's face image captured by the camera into a digital image stream, storing the converted digital image stream in a memory, and generating the driver's face vector template in real-time using the facial recognition technology;
a danger content management unit for storing and managing contents for a danger warning, which are output when a danger is generated within the vehicle;
a driver authentication unit for comparing/analyzing the driver's face vector template generated from the driver face vector template acquisition unit and the driver's face vector template registered with the driver registration unit in order to determine whether the driver is a registered driver, and determining that the danger of burglary exists in the vehicle when an unauthorized person tries to drive the vehicle;
a driver face image reader for generating the driver's face vector template from the digital image stream stored in the memory using the facial recognition technology;
an inter-vehicle safety situation determination unit for continuously monitoring the driver's safety situation within the vehicle by comparing/analyzing the driver's face vector template, which is generated in real-time from the driver face vector template acquisition unit after user authentication, and the driver's face vector template registered with the driver registration unit;
a danger content output unit for outputting contents for a burglar alarm or emergency situations when the driver authentication unit or the inter-vehicle safety situation determination unit determines that the danger of robbery or an emergency situation has occurred within the vehicle; and
a communication unit for providing the stored driver face vector template, authorization information and images of the vehicle, information and images of the vehicle's danger of burglary, information and images of an emergency situation within the vehicle, and the vehicle's position information to the outside through a wireless Internet communication, and
wherein the danger prevention server comprises:
a member registration unit for registering an owner of the danger preventive apparatus, who is provided with various services for robbery and danger prevention through a wireless Internet, as a member, and storing the owner's ordinary face vector template, who drives the vehicle having the danger preventive apparatus mounted therein, in a member DB;
a helper registration unit for storing and managing information about an external helper to which the vehicle's robbery situation or a driver's dangerous situation will be sent;
a danger content management unit for storing and managing contents for robbery prevention and danger;
a server communication unit for receiving the stored driver face vector template, authorization information and images of the vehicle, information and images of the vehicle's danger of burglary, information and images of an emergency situation within the vehicle, and the vehicle's position information from the danger preventive apparatus through a wireless Internet communication;
a member authentication unit for comparing the driver's face vector template received from the danger preventive apparatus and the owner's face vector template registered with the member DB in order to determine whether the driver is a service member;
a danger content service unit for allowing the danger preventive apparatus to output the contents for robbery prevention and danger, which are stored in the danger preventive apparatus, when information and images of the vehicle's danger of burglary and information and images of the vehicle's emergency situation are stored in the information received from the danger preventive apparatus after member authentication; and
an external helper connection unit for transmitting the occurrence of robbery and a danger, image information, and the vehicle's position information to the external helper when information and images of the vehicle's danger of burglary and information and images of the vehicle's emergency situation are included in the information received from the danger preventive apparatus after member authentication.

7. A danger prevention method employing a facial recognition technology, the method comprising the steps of:
registering a vector template extracted from the face of a driver who drives a vehicle as the vehicle's driver;
converting the face of a driver, which is captured by a camera, into a digital image stream, storing the converted digital image stream in a memory, and generating a small-sized vector template using a facial recognition algorithm;
comparing/analyzing the face vector template of the registered driver and the generated face vector template of the driver in order to determine a real driver;
if an unauthorized person attempts to drive the vehicle in a state where a certain number of mismatches occurs in the driver's face vector template, determining that there is a danger of burglary in the vehicle and stopping the start-up of the vehicle while actuating contents for robbery prevention;
if, as a result of the comparison/analysis, the registered face vector template of the driver is identical to the generated face vector template of the driver, continuously monitoring the vehicle's safety situation within the vehicle by comparing/analyzing the face vector template of the registered driver and a face vector template, which is generated in real-time, or a previous vector template of the driver;
if it is determined that a danger has occurred in the vehicle, outputting contents for danger; and
when robbery or a danger is generated in the vehicle, providing messages and GPS information to an external helper.

8. The method as claimed in claim 7, further comprising the steps of:
allowing the danger preventive apparatus to transmit the face vector template of the registered driver, authorization information and images of the vehicle, information and images of the vehicle's danger of burglary, information and images of the vehicle's emergency situation, and the vehicle's position information to the danger prevention server over a wireless Internet communication;
allowing the danger prevention server to compare the face vector template of the driver, received from the danger preventive apparatus, with the face vector template of the registered driver in order to determine whether the driver is a member to which services for danger prevention are provided at the server;
if, as a result of the determination, the driver is a registered member, when information about the vehicle's robbery situation or emergency situation is included in the information received from the danger preventive apparatus, allowing the danger preventive apparatus to output contents for robbery prevention, crimes or unexpected dangers; and
providing the external helper with the vehicle's position information, information about emergency situation images within the vehicle, and emergency call vehicle information.
